(19) United States
(12) Patent Application Publication
(10) Pub. No.: US 2026/0260390 A1
(43) Pub. Date: Sep. 3, 2026

(54) IMAGE FUSION METHOD AND APPARATUS, AND COMPUTER DEVICE AND COMPUTER-READABLE STORAGE MEDIUM

(71) Applicant: TCL COMMUNICATION TECHNOLOGY (CHENGDU) LIMITED, Chengdu (CN)

(72) Inventors: Yuxin XU, Chengdu (CN); Jianqing ZENG, Chengdu (CN); Yongxing ZHANG, Chengdu (CN)

(73) Assignee: TCL COMMUNICATION TECHNOLOGY (CHENGDU) LIMITED, Chengdu (CN)

(21) Appl. No.: 18/716,517

(22) PCT Filed: Nov. 11, 2022
(86) PCT No.: PCT/CN2022/131517

§ 371 Date: Jun. 5, 2024

(30) Foreign Application Priority Data
Dec. 15, 2021 (CN) 202111534760.7

(51) Int. Cl. G06T 11/00; G06T 7/00; G06T 7/11; G06T 7/13; G06T 7/194

(52) U.S. Cl. CPC G06T 11/00; G06T 7/0002; G06T 7/11; G06T 7/13; G06T 7/194; G06T 2207/20221; G06T 2207/30196; G06T 2210/62

(57) ABSTRACT

Provided in the embodiments of the present application are an image fusion method and apparatus, and a computer device and a computer-readable storage medium. The method comprises: acquiring several candidate images of a photographed object for the same photographing background; performing image segmentation on each of the candidate images, so as to obtain an object image of the photographed object and a background image of the photographing background in the candidate image; performing background fusion processing on the background images, so as to obtain a fused background image; and performing object fusion processing on the object image and the fused background image, so as to obtain a target image. By means of the embodiments of the present application, ghosting can be prevented from occurring in a photographed object in a target image.

This Application claims priority of China Patent Application entitled “IMAGE FUSION METHOD AND APPARATUS, AND COMPUTER DEVICE AND COMPUTER-READABLE STORAGE MEDIUM”, Application No. CN202111534760.7, filed Dec. 15, 2021, the entirety of which is incorporated by reference herein.

### TECHNICAL FIELD

This application relates to the field of image processing technology, and particularly, to an image fusion method and apparatus, and computer device and computer-readable storage medium.

### BACKGROUND ART

With the development of smart phones, people have an increasing demand for the photo-taking function of cameras of mobile phones. Cameras of mobile phones have a long exposure function, which can be used to take dynamic photos of traffic, flowing water, etc.

However, the long exposure function is not suitable for taking images with a target, which can be a person or an object. The long exposure function requires a relatively long shooting time, for example, the shooting time is tens of seconds or even longer. Therefore, the subject is required to remain motionless, otherwise the subject will appear as a ghost in the captured image.

### SUMMARY OF INVENTION

### Technical Problem

The technical problem to be solved by the present application is how to avoid ghosting of the photographed target in the image.

### Solution to Problem

### Technical Solution

In order to solve the above technical problem, the technical solutions adopted in the application are as follows:

The embodiments of the present application provide an image fusion method, apparatus, computer device, and computer-readable storage medium, which can avoid ghosting of a photographed object in an image.

An image fusion method, comprising:
acquiring a plurality of candidate images of a photographed object for the same photographing background;
performing image segmentation on the candidate images to obtain object images of the photographed object and background images of the photographing background in the candidate images;
performing background fusion processing on the background images to obtain a fused background image;
performing object fusion processing on the object images and the fused background image to obtain a target image.

Accordingly, an embodiment of the present application provides an image fusion apparatus, comprising:
an acquisition unit configured to acquire a plurality of candidate images of a photographed object for the same photographing background;
a segmentation unit configured to perform image segmentation on the candidate images to obtain object images of the photographed object and background images of the photographing background in the candidate images;
a first fusion unit configured to perform background fusion processing on the background images to obtain a fused background image;
a second fusion unit configured to perform object fusion processing on the object images and the fused background image to obtain a target image.

In some embodiment, the first fusion unit is specifically configured to determine a fused area of the background images; perform the background fusion processing on the background images based on the fused area to obtain the fused background image.

In some embodiment, the first fusion unit is specifically configured to determine that the object images corresponding to the background images are mapped to object areas in the background images; perform regional fusion processing on the object areas to obtain a non-fused area; determine the fused area of the background images based on the non-fused area.

In some embodiment, the first fusion unit is specifically configured to obtain transparency of the fused area; based on the transparency of the fused area, superimposing the background images to obtain the fused background image.

In some embodiment, the second fusion unit is configured to obtain sharpness values of the object images; based on the sharpness values of the object images, select a target object image from the object images; perform image fusion processing on the target object image and the fused background image to obtain the target image.

In some embodiment, the second fusion unit is specifically configured to perform edge detection on an object in the object image to obtain a pixel value of each pixel point on an edge of the object in the object image; perform fusion processing on the pixel values of the respective pixel points on the edge of the object to obtain a fused pixel value; determine the fused pixel value as the sharpness value of the object image.

In some embodiment, the photographed object is a portrait; the segmentation unit is specifically configured to perform portrait detection on each candidate image; if there is a portrait in the candidate image, performing the image segmentation on the candidate image to obtain the object image of the portrait and the background image of the photographing background in the candidate image.

In addition, an embodiment of the present application further provides a computer device, comprising a memory and a processor; the memory storing a computer program, and the processor configured to run the computer program in the memory to perform the operation in any image fusion method provided in the embodiment of the present application.

In addition, an embodiment of the present application further provides a computer-readable storage medium. The computer-readable storage medium stores a computer program, and the computer program is applied for being loaded by a processor to perform the image fusion method provided in the embodiment of the present application.

### Advantageous Effects of Invention

### Advantageous Effects

Compared with the prior art, the embodiments of the present application can require several candidate images of a photographed object for the same shooting background; perform image segmentation on the candidate images to obtain object images of the photographed object and background images of the photographing background in the candidate images; perform background fusion processing on the background images to obtain a fused background image; perform object fusion processing on the object images and the fused background image to obtain a target image. Since the embodiment of the present application can segment the object images of the photographed object and the background images of the photographing background from the candidate images, the embodiment of the present application can fuse the fused background image obtained by fusing the background images and the object images, thereby avoiding directly superposing the several candidate images to achieve the fusion, and further thereby avoiding the occurrence of ghosting of the photographed object in the target image.

### BRIEF DESCRIPTION OF DRAWINGS

### Description of Drawings

In order to more clearly illustrate the technical solutions in the embodiments of the present application, the drawings required for use in the description of the embodiments will be briefly introduced below. Obviously, the drawings described below are only for some embodiments of the present application. For a person of ordinary skill in the art, other drawings can be obtained based on these drawings without creative work.

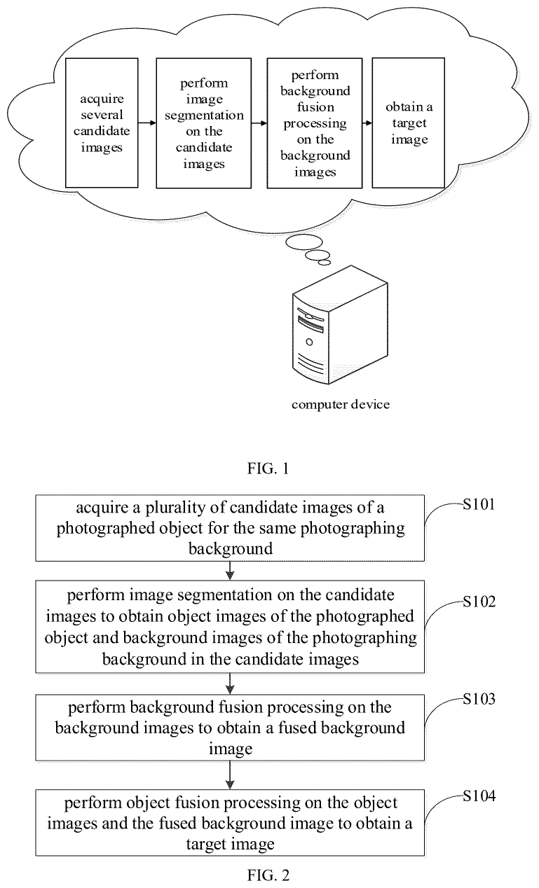

FIG. 1 is a schematic diagram of a scene for an image fusion method provided in an embodiment of the present application;

FIG. 2 is a schematic diagram of a flow chart of an image fusion method provided in an embodiment of the present application;

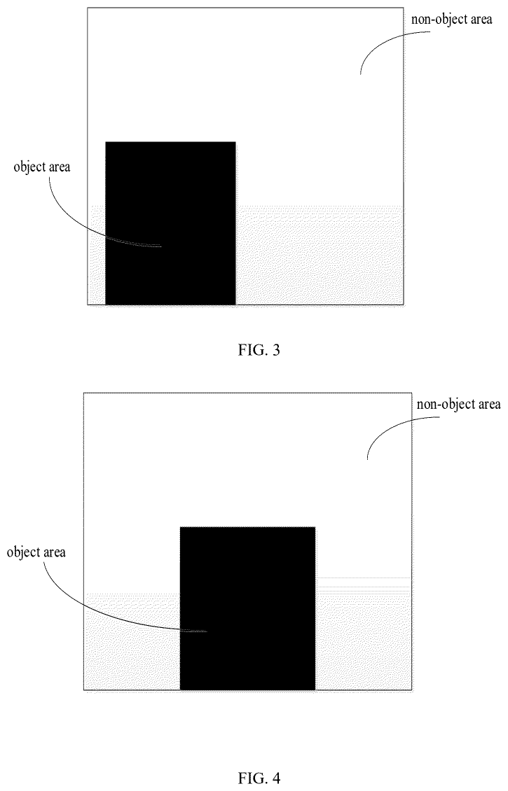

FIG. 3 is a schematic diagram showing a first background image provided in an embodiment of the present application;

FIG. 4 is a schematic diagram showing a second background image provided in an embodiment of the present application;

FIG. 5 is a schematic diagram showing a non-fused area and a fused area provided in an embodiment of the present application;

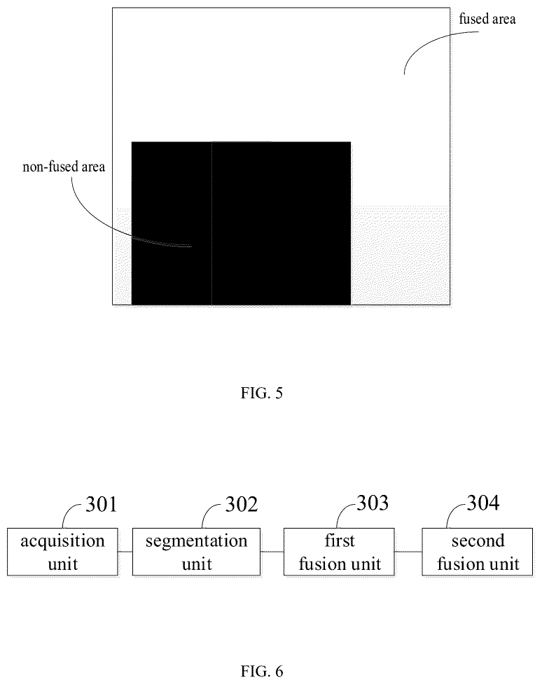

FIG. 6 is a schematic diagram of a structure of an image fusion device provided in an embodiment of the present application;

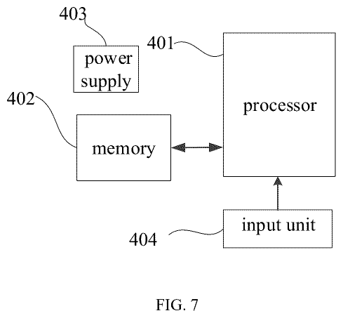

FIG. 7 is a schematic diagram of a structure of a computer device provided in an embodiment of the present application.

### INVENTIVE EMBODIMENTS

### Embodiments of Invention

The technical solutions in the embodiments of the present application will be clearly and completely described below with reference to the accompanying drawings in the embodiments of the present application. Obviously, the described embodiments are merely some of the embodiments of the present application, but not all of the embodiments. Based on the embodiments in the present application, all other embodiments obtained by those skilled in the art without making creative efforts fall within the claimed scope of the present application.

Embodiments of the present application provide an image fusion method and apparatus, computer device, and computer-readable storage medium, wherein the image fusion device may be integrated into the computer device, and the computer device may be a server or a terminal.

Wherein, the server can be an independent physical server, a server cluster or distributed system composed of a plurality of physical servers, or a cloud server that provides basic cloud computing services such as cloud services, cloud databases, cloud computing, cloud functions, cloud storage, network services, cloud communications, middleware services, domain name services, security services, network acceleration services (Content Delivery Network, CDN) as well as big data and artificial intelligence platforms. The terminal may be a smart phone, a tablet computer, a laptop computer, a desktop computer, a smart speaker, a smart watch, etc., but the present application is not limited thereto. The terminal and the server may be connected each other directly or indirectly via wired or wireless communication, which is not limited in the application.

For example, referring to FIG. 1, taking an image fusion device integrated in a computer device as an example, the computer device acquires several candidate images of a photographed object for the same photographing background; performs image segmentation on the candidate images to obtain object images of the photographed object and background images of the photographing background in the candidate images; performs background fusion processing on the background images to obtain a fused background image; performs object fusion processing on the object images and the fused background image to obtain a target image.

Wherein, the same photographing background means a situation in which among several candidate images, the photographing background of each candidate image is mostly the same, which can be called the same photographing background; or a situation in which among several candidate images, the photographing background of each candidate image is exactly the same, which can be called the same photographing background.

Wherein, the photographed object may be a person, a moving object, a plant, etc.

Wherein, the photographing background may be flowing water, traffic, natural scenery, etc.

The following are detailed descriptions. It should be noted that the description order of the following embodiments is not intended to limit the preferred order of the embodiments.

The embodiment will be described from the perspective of an image fusion device. The image fusion device can be specifically integrated in a computer device. The computer device can be a server or a terminal; wherein the terminal can comprise a tablet computer, a laptop computer, a personal computer (PC), a wearable device, a virtual reality device, or another smart device that can acquire data.

As shown in FIG. 2, the specific process of the image fusion method is as follows:

S101: acquiring a plurality of candidate images of a photographed object for the same photographing background.

Wherein, the same photographing background means a situation in which among several candidate images, the photographing background of each candidate image is mostly the same, which can be called the same photographing background; or, a situation in which among several candidate images, the photographing background of each candidate image is exactly the same, which can be called the same shooting background.

Wherein, the photographed object may be a person, a moving object, a plant, etc.

Wherein, the photographing background may be flowing water, traffic, natural scenery, etc.

There are multiple ways to acquire several candidate images of the object for the same photographing background in the embodiments of the present application. For example, a computer device starts a camera mode; the computer device uses a long exposure mode for the same photographing background in response to a user's selection operation to photograph, thereby acquiring several candidate images.

For another example, the computer device photographs for the same photographing background in response to a photographing operation triggered by a user, thereby acquiring several candidate images.

Wherein, the photographing operation may be a photographing operation for countdown photographing. For example, the computer device performs the photographing operation only after the countdown of 10 seconds is finished, or the photographing operation can also be a direct photographing operation. For example, when the shutter button of the computer device is pressed, the computer device directly performs the photographing operation.

S102: performing image segmentation on the candidate images to obtain object images of the photographed object and background images of the photographing background in the candidate images.

Wherein, the embodiment of the present application may use an image segmentation model to segment each of the candidate images, separate the background and foreground each of the candidate images, and thus obtain an object image of the photographed object and a background image of the photographing background in each of the candidate images.

The embodiment of the present application may use a background differential method to separate the background and foreground of each of the candidate images, thereby obtaining an object image of the photographed object and a background image of the photographing background in the candidate image.

Specifically, when the photographed object is a portrait, the embodiment of the present application can perform portrait detection on each candidate image; if there is a portrait in a candidate image, the image segmentation is performed on the candidate image to obtain an object image of the portrait and a background image of the photographing background in the candidate image.

Wherein, the embodiment of the present application can use a portrait recognition model to perform the portrait detection on each of the candidate images, thereby separating the object image of the portrait and the background image.

S103: performing background fusion processing on the background images to obtain a fused background image.

Specifically, the embodiment of the present application can set the transparency of the background images, and the transparency can be set to ten percent; then, the respective background images are directly superimposed to achieve the fusion processing, thereby obtaining the fused background image.

Specifically, the embodiment of the present application performs the background fusion processing on the background image, and obtains the fused background image further in the following manner:

For example, the computer device determines a fused area of the background images; based on the fused area, the background fusion processing is performed on the background images to obtain the fused background image.

Wherein, the manner for determining the fused area of the background images in the embodiment of the present application can be performed: by the computer device, determining that the object images corresponding to the background images are mapped to object areas in the background images; performing regional fusion processing on the object areas to obtain a non-fused area; determining the fused area of the background images based on the non-fused area.

In the embodiment of the present application, for each of the candidate images, the candidate image is segmented to obtain an object image and a background image corresponding to the candidate image. That is, the object images correspond to the background images respectively. Accordingly, the object area in the background image refers to the area where the area occupied by the object image is overlapped with the background image in the candidate image corresponding to the object image.

The embodiment of the present application aligns the respective background images to obtain aligned background images; superimposes the object areas corresponding to the respective aligned background images, and the total area occupied after the superposition is the non-fused area.

For example, the present application takes two candidate images as an example for explanation. The embodiment of the present application segments the two candidate images separately to obtain two background images and object images corresponding to the respective background images. The two background images are respectively a first background image and a second background image.

As shown in FIG., FIG. 3 shows the first background image. The first background image comprises an object area and a non-object area. The object area in FIG. 3 is located on the left, that is, the object image corresponding to the first background image is located on the left side of the candidate image corresponding to the first background image.

As shown in FIG. 4, FIG. 4 shows the second background image. The second background image comprises an object area and a non-object area. The object area in FIG. 4 is located in the middle, that is, the object image corresponding to the second background image is located in the middle of the candidate image corresponding to the second background image.

In the embodiment of the present application, after the object area of the first background image and the object area of the second background image are superimposed, the non-fused area is obtained. As shown in FIG. 5, the area outside the non-fused area is a fused area.

Based on the above description, the embodiment of the present application obtains the transparency of the fused area; based on the transparency of the fused area, the background images are superimposed to obtain the fused background image.

The embodiment of the present application can directly align and superimpose the background images at a transparency of 10 percent.

S104: performing object fusion processing on the object images and the fused background image to obtain a target image.

Wherein, the embodiment of the present application can select a target object image from the several object images, and perform image fusion processing on the target object image and the fused background image to obtain the target image.

Specifically, the computer device obtains sharpness values of the object images; based on the sharpness values of the object images, the target object image is selected from the object images; and the image fusion processing is performed on the target object image and the fused background image to obtain the target image.

Wherein, for each of the object images, the embodiment of the present application can perform edge detection on the object in the object image to obtain a pixel value of each pixel point on the edge of the object in the object image; perform fusion processing on the pixel values of the respective pixel points on the edge of the object to obtain a fused pixel value; and determine the fused pixel value as the sharpness value of the object image.

The embodiment of the present application performs the fusion processing on the pixel values of the respective pixel points on the edge of the object to obtain the fused pixel value by directly adding the pixel values of the respective pixel points on the edge of the object in the object image; or fusing the pixel values of the respective pixel points on the edge of the object in the object image using weights.

The embodiment of the present application may perform the edge detection on an object in an object image by using a Sobel operator, or may perform the edge detection on an object in an object image by using an image edge detection model.

The object image with the largest sharpness value is the clearest object image. The embodiment of the present application may determine the object image with the largest sharpness value as the target object image.

The embodiments of the present application can acquire several candidate images of a photographed object for the same photographing background; perform image segmentation on the candidate images to obtain object images of the photographed object and background images of the photographing background in the candidate images; perform background fusion processing on the background images to obtain a fused background image; perform object fusion processing on the object images and the fused background image to obtain a target image. Since the embodiment of the present application can segment the object images of the photographed object and the background images of the photographing background from the candidate images, the embodiment of the present application can fuse the fused background image obtained by fusing the background images and the object images, thereby avoiding directly superposing the several candidate images to achieve the fusion, and further thereby avoiding the occurrence of ghosting of the photographed object in the target image.

In order to better implement the above method, the embodiment of the present application also provides an image fusion apparatus. The image fusion apparatus can be integrated into a computer device, such as a server or a terminal. The terminal may comprise a tablet computer, a laptop computer and/or a personal computer.

For example, as shown in FIG. 6, the image fusion apparatus may comprise an acquisition unit 301, a segmentation unit 302, a first fusion unit 303 and a second fusion unit 304, as follows:

### (1) Acquisition Unit

The acquisition unit can be configured to acquire several candidate images of a photographed object for the same photographing background.

### (2) Segmentation Unit

The segmentation unit can be configured to perform image segmentation on the candidate images to obtain object images of the photographed object and background images of the photographing background in the candidate images.

In some embodiments, the photographed object is a portrait; the segmentation unit can be configured to perform portrait detection on each candidate image; if there is a portrait in a candidate image, perform image segmentation on the candidate image to obtain an object image of the portrait and a background image of the photographing background in the candidate image.

### (3) First Fusion Unit

The first fusion unit is configured to perform background fusion processing on the background images to obtain a fused background image.

In some embodiments, the first fusion unit may be specifically configured to determine a fused area of the background images; based on the fused area, perform background fusion processing on the background images to obtain the fused background image.

In some embodiments, the first fusion unit can be specifically configured to determine that the object images corresponding to the background images are mapped to object areas in the background images; perform regional fusion processing on the object areas to obtain a non-fused area; and determine the fused area of the background images based on the non-fused area.

In some embodiments, the first fusion unit may be specifically configured to obtain the transparency of the fused area; based on the transparency of the fused area, superimpose the background images to obtain the fused background image.

### (4) Second Fusion Unit

The second fusion unit can be configured to perform object fusion processing on the object images and the fused background image to obtain a target image.

In some embodiments, the second fusion unit can be specifically configured to obtain the sharpness values of the object images; based on the sharpness values of the object images, select a target object image from the object images; perform image fusion processing on the target object image and the fused background image to obtain the target image.

In some embodiments, the second fusion unit can be specifically configured to perform edge detection on the object in the object image to obtain pixel values of pixel points on the edge of the object in the object image; perform fusion processing on the pixel values of pixel points on the edge of the object to obtain a fused pixel value; and determine the fused pixel value as the sharpness value of the object image.

The acquisition unit of the embodiment of the present application can be configured to acquire several candidate images of a photographed object for the same shooting background; the segmentation unit can be configured to perform image segmentation on the candidate images to obtain the object images of the photographed object and the background images of the photographing background in the candidate images; the first fusion unit can be configured to perform background fusion processing on the background images to obtain a fused background image; the second fusion unit can be configured to perform object fusion processing on the object images and the fused background image to obtain a target image. Since the embodiment of the present application can segment the object images of the photographed object and the background images of the photographing background from the candidate images, the embodiment of the present application can fuse the fused background image obtained by fusing the background images and the object images, thereby avoiding directly superposing the several candidate images to achieve the fusion, and further thereby avoiding the occurrence of ghosting of the photographed object in the target image.

The embodiment of the present application further provides a computer device, as shown in FIG. 7, which shows a schematic diagram of a structure of the computer device involved in the embodiment of the present application, specifically:

The computer device may comprise components such as a processor 401 of one or more processing cores, a memory 402 of one or more computer-readable storage media, a power supply 403 and an input unit 404. Those skilled in the art will appreciate that the structure of the computer device shown in FIG. 7 does not be provided a limitation on the computer device, and the computer device may comprise more or fewer components than shown in the figure, or a combination of certain components, or a different arrangement of components. Wherein:

The processor 401 is the control center of the computer device, which connects various parts of the entire computer device and performs various functions of the computer device and processes data by running or executing software programs and/or modules stored in the memory 402 and calling data stored in the memory 402, thereby monitoring the computer device as a whole. Optionally, the processor 401 may comprise one or more processing cores; preferably, the processor 401 may integrate an application processor and a modulator-demodulator processor, wherein the application processor mainly processes an operating system, a user interface, and computer programs, etc., and the modulator-demodulator processor mainly processes wireless communications. It is understandable that the above-mentioned modulator-demodulator processor may not be integrated into the processor 401.

The memory 402 may be used to store software programs and modules. The processor 401 performs various functional applications and data processing by running the software programs and modules stored in the memory 402. The memory 402 may mainly comprise a program storage area and a data storage area, wherein the program storage area may store an operating system, a computer program required for at least one function (such as a sound playback function, an image playback function, etc.), etc.; the data storage area may store data created according to the use of the computer device, etc. In addition, the memory 402 may comprise a high-speed random access memory and may further comprise a non-volatile memory, such as at least one disk storage device, a flash device, or other volatile solid-state storage devices. Accordingly, the memory 402 may further comprise a memory controller to provide the processor 401 with access to the memory 402.

The computer device further comprises a power supply 403 for supplying power to various components. Preferably, the power supply 403 can be logically connected to the processor 401 through a power management system, so that the power management system can manage charging, discharging, power consumption and other functions. The power supply 403 may further comprise one or more DC or AC power supplies, a recharging system, a power failure detection circuit, a power converter or inverter, a power status indicator, and other arbitrary components.

The computer device may further comprise an input unit 404. The input unit 404 may be used to receive input digital or character information communication and generate keyboard, mouse, joystick, optical or trackball signal inputs related to user settings and function controls.

Although not shown, the computer device may further comprise a display unit, etc., which will not be described in detail here. Specifically in the embodiment, the processor 401 in the computer device will load executable files corresponding to processes of one or more computer programs into the memory 402 according to the following instructions, and the processor 401 will run the computer programs stored in the memory 402 to implement various functions, as follows:
acquiring several candidate images of a photographed object for the same photographing background; performing image segmentation on the candidate images to obtain object images of the photographed object and background images of the photographing background in the candidate images; performing background fusion processing on the background images to obtain a fused background image; performing object fusion processing on the object images and the fused background image to obtain a target image.

The specific implementation of the above operations can be found in the previous embodiments, which will not be described in detail here.

A person of ordinary skill in the art will appreciate that all or part of the steps in the various methods of the above embodiments may be completed by a computer program, or by controlling related hardware through a computer program. The computer program may be stored in a computer-readable storage medium and loaded and executed by a processor.

Accordingly, an embodiment of the present application provides a computer-readable storage medium, in which a computer program is stored. The computer program can be loaded by a processor to perform any image fusion method provided in the embodiments of the present application.

The specific implementation of the above operations can be found in the previous embodiments, which will not be described in detail here.

Wherein, the computer-readable storage medium may comprise: a read-only memory (ROM), a random access memory (RAM), a magnetic disk or an optical disk, etc.

Since the instructions stored in the computer-readable storage medium can perform the steps in any image fusion method provided in the embodiments of the present application, the beneficial effects that can be achieved by any image fusion method provided in the embodiments of the present application can be achieved. Please refer to the previous embodiments for details, and the related description is not repeated here.

Wherein, according to one aspect of the present application, a computer program product or a computer program is provided. The computer program product or the computer program comprises computer instructions, and the computer instructions are stored in a computer-readable storage medium. The processor of the computer device reads the computer instruction from the computer-readable storage medium, and the processor executes the computer instruction, so that the computer device performs the methods provided in the various optional implementations provided in the above embodiments.

There is a detailed introduction to an image fusion method, apparatus, computer device and computer-readable storage medium provided in the embodiments of the present application. Specific examples are used in the specification to illustrate the principles and implementation of the present application. The description of the above embodiments is only used to help understanding the method of the present application and its core idea; at the same time, for a person of ordinary skill in the art, according to the idea of the present application, there will be changes in the specific implementation and application scopes. In summary, the content of the specification should not be understood as a limitation on the present application.

1. An image fusion method, comprising:
acquiring a plurality of candidate images of a photographed object for the same photographing background;
performing image segmentation on the candidate images to obtain object images of the photographed object and background images of the photographing background in the candidate images;
performing background fusion processing on the background images to obtain a fused background image;
performing object fusion processing on the object images and the fused background image to obtain a target image.

2. The image fusion method according to claim 1, wherein performing background fusion processing on the background images to obtain a fused background image comprises:
determining a fused area of the background images;
performing the background fusion processing on the background images based on the fused area to obtain the fused background image.

3. The image fusion method according to claim 2, wherein determining a fused area of the background images comprises:
determining that the object images corresponding to the background images is mapped to object areas in the background images;
performing regional fusion processing on the object areas to obtain a non-fused area;
determining the fused area of the background images based on the non-fused area.

4. The image fusion method according to claim 2, wherein performing the background fusion processing on the background images based on the fused area to obtain the fused background image comprises:
obtaining transparency of the fused area;
based on the transparency of the fused area, superimposing the background images to obtain the fused background image.

5. The image fusion method according to claim 1, wherein performing object fusion processing on the object images and the fused background image to obtain a target image comprises:
obtaining sharpness values of the object images;
based on the sharpness values of the object images, selecting a target object image from the object images;
performing image fusion processing on the target object image and the fused background image to obtain the target image.

6. The image fusion method according to claim 5, wherein obtaining sharpness values of the object images comprises:
performing edge detection on an object in the object image to obtain a pixel value of each pixel point on an edge of the object in the object image;
performing fusion processing on the pixel values of the respective pixel points on the edge of the object to obtain a fused pixel value;
determining the fused pixel value as the sharpness value of the object image.

7. The image fusion method according to claim 6, wherein performing fusion processing on the pixel values of the respective pixel points on the edge of the object to obtain a fused pixel value comprises:
adding the pixel values of the respective pixel points on the edge of the object in the object image to obtain the fused pixel value.

8. The image fusion method according to claim 6, wherein the target object image is the object image with the largest sharpness value.

9. The image fusion method according to claim 1, wherein performing image segmentation on the candidate images to obtain object images of the photographed object and background images of the photographing background in the candidate images comprises:
performing the image segmentation on the candidate images using an image segmentation model obtain the object images of the photographed object and the background images of the photographing background in the candidate images.

10. The image fusion method according to claim 1, wherein the photographed object is a portrait; performing image segmentation on the candidate images to obtain object images of the photographed object and background images of the photographing background in the candidate images comprises:
performing portrait detection on each candidate image;
if there is a portrait in the candidate image, performing the image segmentation on the candidate image to obtain the object image of the portrait and the background image of the photographing background in the candidate image.

11. An image fusion apparatus, wherein comprising:
an acquisition unit configured to acquire a plurality of candidate images of a photographed object for the same photographing background;
a segmentation unit configured to perform image segmentation on the candidate images to obtain object images of the photographed object and background images of the photographing background in the candidate images;
a first fusion unit configured to perform background fusion processing on the background images to obtain a fused background image;
a second fusion unit configured to perform object fusion processing on the object images and the fused background image to obtain a target image.

12. The image fusion apparatus according to claim 11, wherein the first fusion unit is configured to:
determine a fused area of the background images;
perform the background fusion processing on the background images based on the fused area to obtain the fused background image.

13. The image fusion apparatus according to claim 12, wherein the first fusion unit is configured to:
determine that the object images corresponding to the background images are mapped to object areas in the background images;
perform regional fusion processing on the object areas to obtain a non-fused area;
determine the fused area of the background images based on the non-fused area.

14. The image fusion apparatus according to claim 12, wherein the first fusion unit is configured to:
obtain transparency of the fused area;
based on the transparency of the fused area, superimposing the background images to obtain the fused background image.

15. The image fusion apparatus according to claim 11, wherein the second fusion unit is configured to:
obtain sharpness values of the object images;
based on the sharpness values of the object images, select a target object image from the object images;
perform image fusion processing on the target object image and the fused background image to obtain the target image.

16. The image fusion apparatus according to claim 15, wherein the second fusion unit is configured to:
perform edge detection on an object in the object image to obtain a pixel value of each pixel point on an edge of the object in the object image;
perform fusion processing on the pixel values of the respective pixel points on the edge of the object to obtain a fused pixel value;
determine the fused pixel value as the sharpness value of the object image.

17. The image fusion apparatus according to claim 16, wherein the second fusion unit is configured to:
adding the pixel values of the respective pixel points on the edge of the object in the object image to obtain the fused pixel value.

18. The image fusion apparatus according to claim 11, wherein the photographed object is a portrait; the segmentation unit is configured to:
perform portrait detection on each candidate image;
if there is a portrait in the candidate image, performing the image segmentation on the candidate image to obtain the object image of the portrait and the background image of the photographing background in the candidate image.

19. A computer device, wherein, comprising a memory and a processor; the memory storing a computer program, and the processor configured to run the computer program in the memory to perform the image fusion method according to claim 1.

20. A non-volatile computer-readable storage medium, wherein the computer-readable storage medium stores a computer program, and the computer program is applied for being loaded by a processor to perform the image fusion method according to claim 1.
